(19) United States
(12) Patent Application Publication
(10) Pub. No.: US 2005/0028631 A1
(43) Pub. Date: Feb. 10, 2005

(54) Compact short-throw shifter linkage

(76) Inventor: Steven Alan Watkins, Placentia, CA (US)

Correspondence Address: Steven A. Watkins, 1322 E. Orangethorpe Ave., Fullerton, CA, 92831, US

(21) Appl. No.: 10/913,603

(22) Filed: Aug. 5, 2004

Related U.S. Application Data
(60) Provisional application No. 60/492,909, filed on Aug. 5, 2003.

(51) Int. Cl. G05G 9/00

(52) U.S. Cl. 74/473.1

(57) ABSTRACT

Many automotive enthusiasts wish to reduce the range of motion (throw) required to shift gears in their vehicles. The present invention, uses a Class 3 Leverage action, optionally folded in articulation and co-acting with a sculptured Fulcrum Rod, to provide a compact, bolt-on, short-throw, shifter linkage that retrofits completely within a vehicle shifter housing's space constraints without deleteriously altering the vehicle. Such shifter housing space constraints have previously militated against many attempts to retrofit aftermarket short-throw shifter means into existing vehicles.

### CROSS-REFERENCE TO RELATED APPLICATIONS

This application claims the benefit of provisional patent application Ser. No. 60/492,909 filed Aug. 05, 2003, incorporated herein by reference.

### FEDERALLY SPONSORED RESEARCH: Not Applicable

### SEQUENCE LISTING OR PROGRAM: Not Applicable

### BACKGROUND OF THE INVENTION

1. Field of the Invention

The present invention relates to aftermarket, hand operated, vehicle transmission control lever linkage mechanisms, sometimes known as ‘quick shifters’ or ‘short shifters’. Specifically, means to reduce the range of motion, i.e. the ‘throw’, required for the driver to manually shift gears in vehicles. Said means to exist entirely within the limited space constraints found in newer vehicles.

2. Description of the Related Art

Many mechanisms have been created over the years to reduce vehicle transmission shifter throw. Existing aftermarket short-throw shifters declare shift-throw reductions of 20% to 50%.

Typically, extending a shifter handle lever's length between the fulcrum and the load reduces the throw angle by a proportional amount. Unfortunately, many of today's vehicles do not permit the space luxury of lever lengthening.

Alternatively, levers at the transmission itself can be shortened to reduce the shifter throw. However, many cable shifted transmissions do not have external levers, the cables go directly into the transmission case.

### SUMMARY OF THE INVENTION

It is an object of the present invention to provide a compact means to shorten a vehicle shifter's throw which fits within the space constraints of the vehicle's shifter mechanism and housing.

It is also an object of the present invention to permit shortening the shifter throw by 90% or more, if desired.

It is another object of the present invention to provide an aftermarket short-throw shifter modification means without excessively altering the vehicle with undue cutting, drilling, welding, or other deleterious modifications.

It is a further object of the present invention for the short-throw shifter linkage to accommodate the multiple linear and rotational axis movements of the shifter handle and linkage as they are operated through their range of motion.

A salient feature of the present invention employs a Class 3 Lever which may be folded in articulation, and optionally combined with a contoured Fulcrum Rod, to reduce the space necessary to retrofit a short-throw shifter mechanism completely inside the confined space of an existing vehicle's console and boot housing. The Class 3 lever also permits greater reduction in shifter throw than existing means.

Another embodiment of the present invention trans-locates the existing shifter linkage, determined by the length of an Effort Arm, to provide room for Class 3 Lever articulation.

### DESCRIPTION OF THE DRAWINGS

FIG. 1 shows a perspective view of a short-throw shifter linkage embodiment of the present invention.

FIG. 2 is a side view representation of FIG. 1, showing a leverage arrangement and space constraint accommodation of the present invention, illustrating a Transmission Linkage operated in its retracted and extended positions.

FIG. 3 shows an alternate Fulcrum Rod arrangement of FIG. 2.

FIG. 4 shows the present invention operating below the Shifter Fulcrum.

FIG. 5 also shows the present invention operating below the Shifter Fulcrum, with an Effort Arm, and an extended Linkage Entrance Bracket.

FIGS. 6 and 7 show lever Fulcrum Cable arrangements.

FIGS. 8A thru 8D show some typical shifter ‘H’ patterns.

### REFERENCE NUMERALS

| | |
|---|---|
| 10 Short Throw Shift Angle | 12 Factory Throw Shift Angle |
| 14 Lever - Class 3 | 16 Shifter Handle Lever Point |
| 18 Fulcrum Point | 20 Load Lever Point |
| 22 Shifter Handle Lever | 24 Transmission Link Rod |
| 26 Linkage Stroke Distance | 28 Shifter Handle Fulcrum |
| 30 Fulcrum means | 32 Shifter Housing |
| 34 Shifter Boot | 36 Fulcrum Means End |
| 38 Trans. Link Rod End | 40 Linkage Entrance Bracket |
| 42 Shifter Frame | 44 Attachment means |
| 46 Effort Arm | 48 Lever Offset distance |
| 50 Fulcrum Cable | 52 Redirection Means |

### DETAILED DESCRIPTION OF THE PREFERRED EMBODIMENT

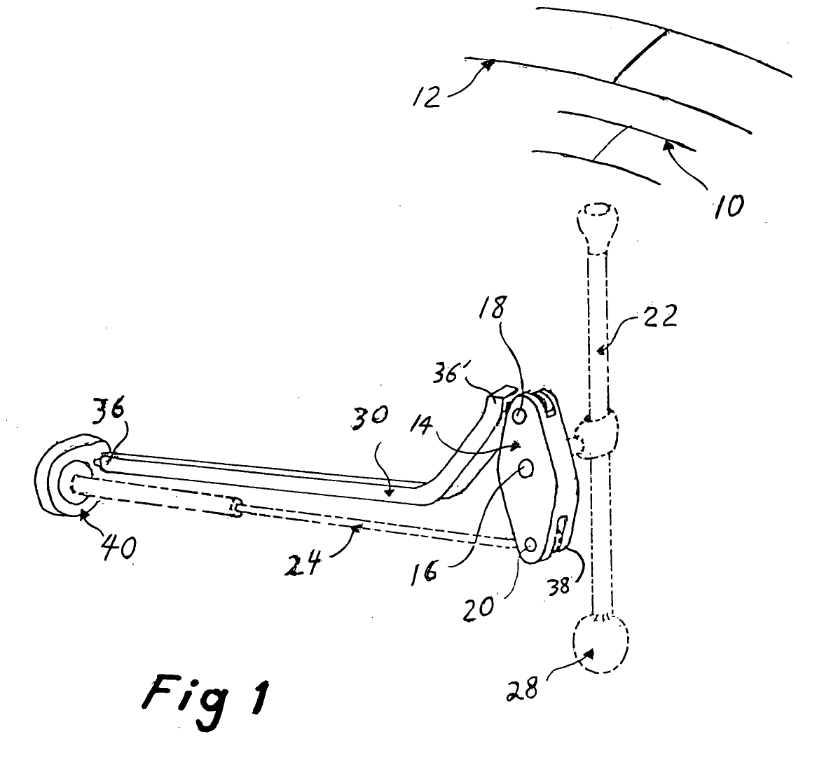

In FIG. 1, the Shortened-Throw Shifting Angle 10, of the present invention modifies the Factory-Throw Shifting Angle 12, by using a Class 3 Lever 14 where the Effort Point 16 lies between Fulcrum Point 18 and Load Point 20 thereby acting as a motion multiplying device.

The shifter throw shortening ratio of a Class 3 Lever, also known as a “third-class lever”, is directly proportional to the distance between the Effort and the Load, divided by the distance between the Fulcrum and the Load. As this number ranges between 0 and 1, the Short-Throw Shift Ratio ranges between 0% reduction, and 100% reduction. Referring to FIGS. 1 thru 7, this ratio is the distance between points 16 and 20, divided by the distance between points 18 and 20.

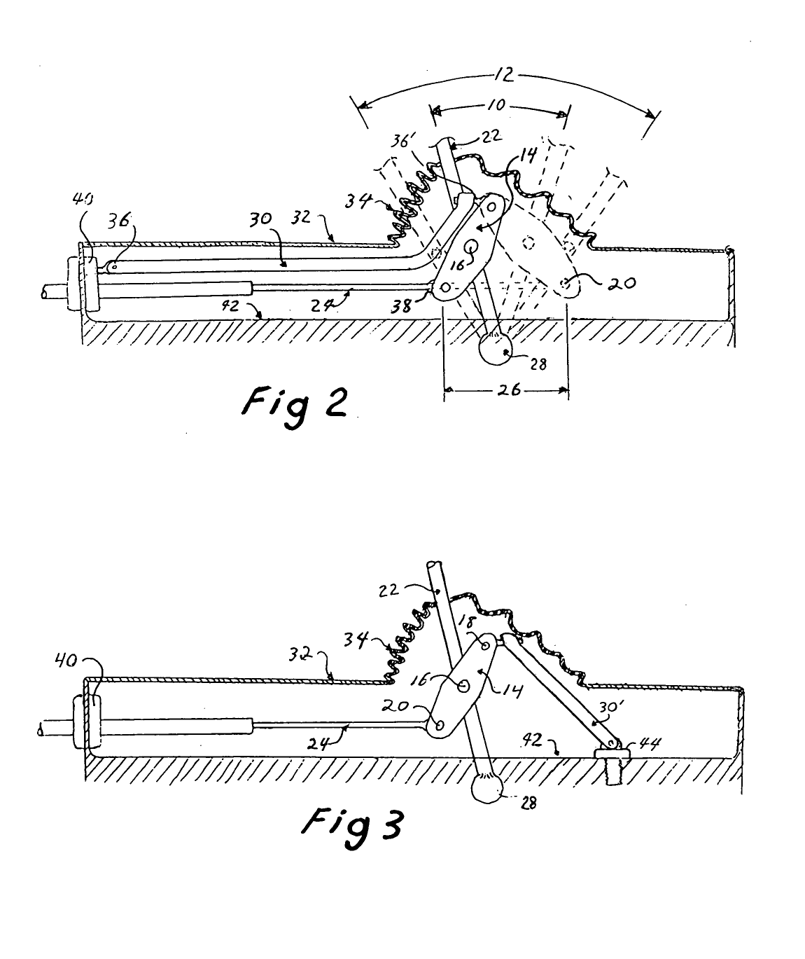

FIG. 2, shows a novelty of the present invention employing Lever 14 positioned to operate inverted with respect to Shifter Lever 22, permitting the vehicle's existing Transmission Linkage Rod 24 to extend and retract its entire design Length Stroke Distance 26 while passing near Shifter Fulcrum 28. This ‘on its head’ operation is defined as a folded lever function, because the Class 3 Lever's action is folded back, with respect to Shifter Lever 22, which desirably (i) applies a low side-thrust force vector to Transmission Linkage Rod 24 and (ii) positions it out of the way to create clearance for linkage articulation.

A further novelty of the present invention, is Fulcrum Rod 30, which is sculptured to clear console Shifter Housing cover 32, and Shifter Boot 34. Furthermore, Fulcrum Rod 30 articulates at both Ends 36 and 36′ by hinge, ball, swivel, universal joint or other means, such as for example, flexible material at each end, to accommodate the inherent multiple linear and rotational axis motion traveled by existing Linkage Rod 24 and Shifter Lever 22 running through ‘H’ pattern Angle 10 as the driver changes gears.

The present invention is designed to conveniently attach to an existing vehicle shifter mechanism at three places; (i) Transmission Linkage Rod End 38 (ii) Shifter Handle Point 16, and (iii) Linkage Rod Entrance Bracket 40. FIG. 2 shows Fulcrum Rod End 36 attached to any suitable Shifter Frame surface 42 such as via Transmission Linkage Entrance Bracket 40. Attachment is made by providing Bracket 40 as a replacement for the original Transmission Linkage Entrance Bracket (not shown). The Bracket 40 modification primarily provides a suitable attachment means, such as a threaded hole, to accommodate Fulcrum Rod End 36. The entire short-throw shifter assembly of the present invention can thereby be attached to the vehicle without needing to violate the integrity of the vehicle. A desirable advantage of the present invention is that upon removal of the short-throw shifter linkage the vehicle is returned to an essentially unaltered state. Such attachments are commonly called ‘bolt-ons’ whether or not bolts are actually used.

FIG. 3 shows two alternative embodiments of FIG. 2, which may be incorporated separately or together, in which (i) a Straight Fulcrum Rod 30′ is positioned (ii) opposite Class 3 Lever 14 from Transmission Linkage Rod 24. Viewing FIG. 2 and FIG. 3 together, one can see that it is permissible for Sculptured Fulcrum Rod 30 of FIG. 2, or Straight Fulcrum Rod 30′ of FIG. 3, to be utilized on either side of Lever 14. If a noninvasive bolt-on means similar to Bracket 40 of FIG. 2 cannot be formed for these Fulcrum Rod embodiments, attachment may be made directly to Shifter Frame 42, as with Attachment means 44 of FIG. 3, using a suitable hole.

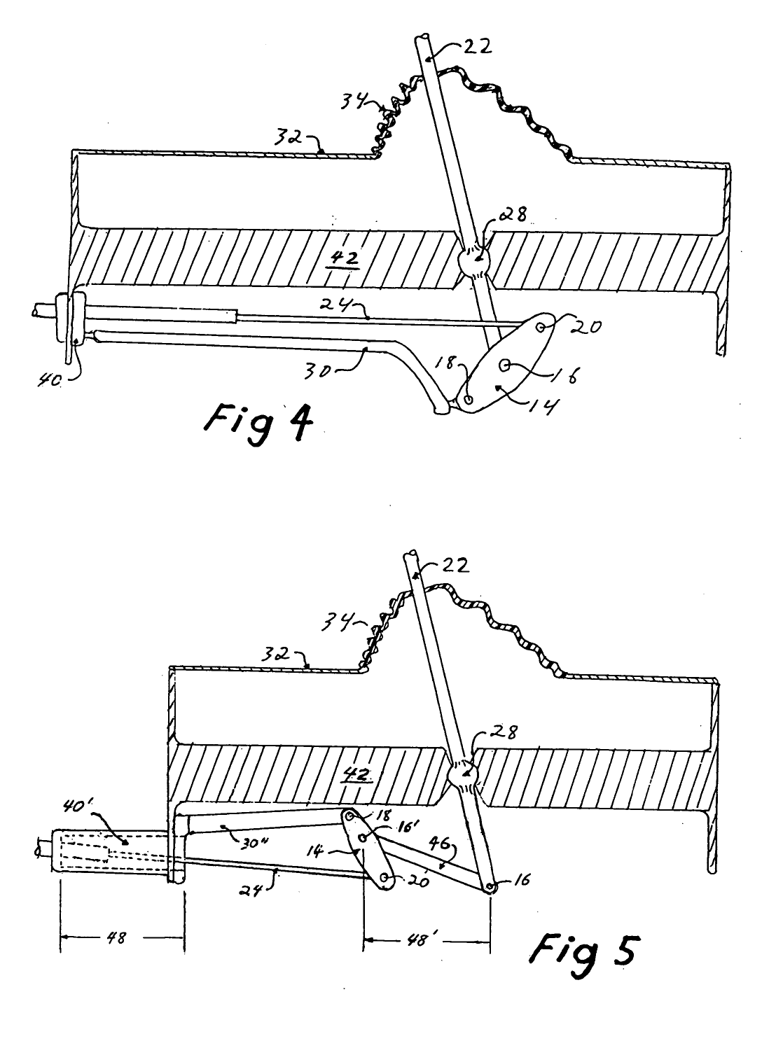

FIG. 4 lever action is virtually identical to those of FIGS. 1-3, and is employed in those vehicles whose transmission linkage attaches to the shifter handle below Shifter Fulcrum 28.

FIG. 5 also attaches to the shifter handle below Shifter Fulcrum 28, and where conditions permit, shows two additional variants of the preferred embodiment: (i) Class 3 leverage action need not be folded, and (ii) Class 3 Lever 14 can be offset from Shifter Handle Lever 22 by Effort Arm 46.

(i) Non-folded Class 3 Lever operation exists where, Fulcrum 18 of Class 3 Lever 14 is situated near Shifter Frame 42, as is Shifter Handle Fulcrum 28, which positions Lever 14 to operate in the same orientation as Shifter Handle 22, in a non-folded attitude.

(ii) An offset Class 3 Lever condition exists by repositioning Transmission Rod 24, substantially the same amount and direction 48, as offset 48′ of Effort Arm 46, using extended Linkage Entrance Bracket 40′. Please note that FIG. 5 shows Effort Arm 46 angled with respect to Shifter Frame 42 demonstrating how this use of Effort Arm 46, is useful when, for instance due to space constraints, Shifter Handle Point 16 is not positioned to permit room for direct attachment of Class 3 Lever 14.

Further, the slope angle of Effort Arm 46, with relation to the orientation of Transmission Rod 24, causes the Offset Distance 48 to actually be the cosine of the included angle, measured in the plane of articulation of the Class 3 Lever 14, between Transmission Rod 24 and Effort Arm 46, when Shifter Handle 22 is at its' most neutral position, which is in the middle of the ‘H’ pattern. For example, an 80 mm long Effort Arm 46 at a 30 deg angle to Transmission Linkage Rod 24 means that, with the cosine of 30 deg being “Sqrt(3)/2=0.866 . . . ”, the associated Offset Distance 48 is Cos 30*80 mm=0.866*80−69.3 mm.

FIG. 5 further shows Fulcrum Means 30″ is rigidly attached, in fact integrated with, Linkage Entrance Bracket 40′, demonstrating that with Effort Arm 46 articulating at both ends to accommodate the multiple axis motion of Shifter Handle 22, such articulation flexibility is not required of Fulcrum Means 30″.

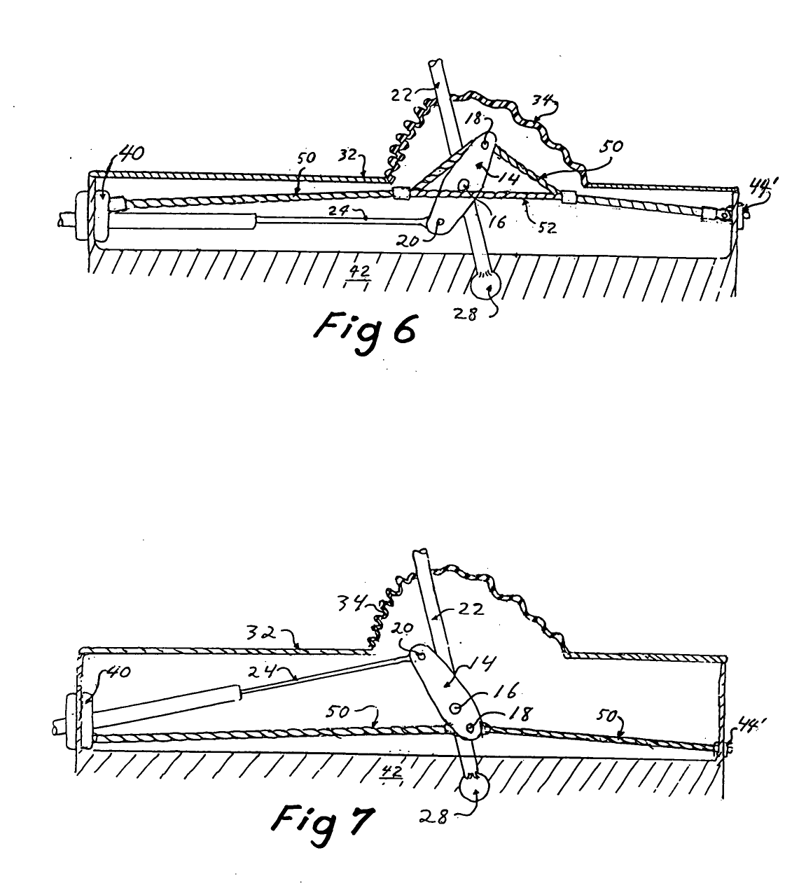

FIGS. 6 & 7 show that lever fulcrums need not be rods. Cable 50 can perform the fulcrum function by tensioning between opposite ends of Shifter Frame 42 attached by Brackets 40 and 44′.

FIG. 6 shows redirection means 52, which itself can optionally also be a cable, assists in routing Fulcrum Cable 50 to clear Shifter Console Housing 32.

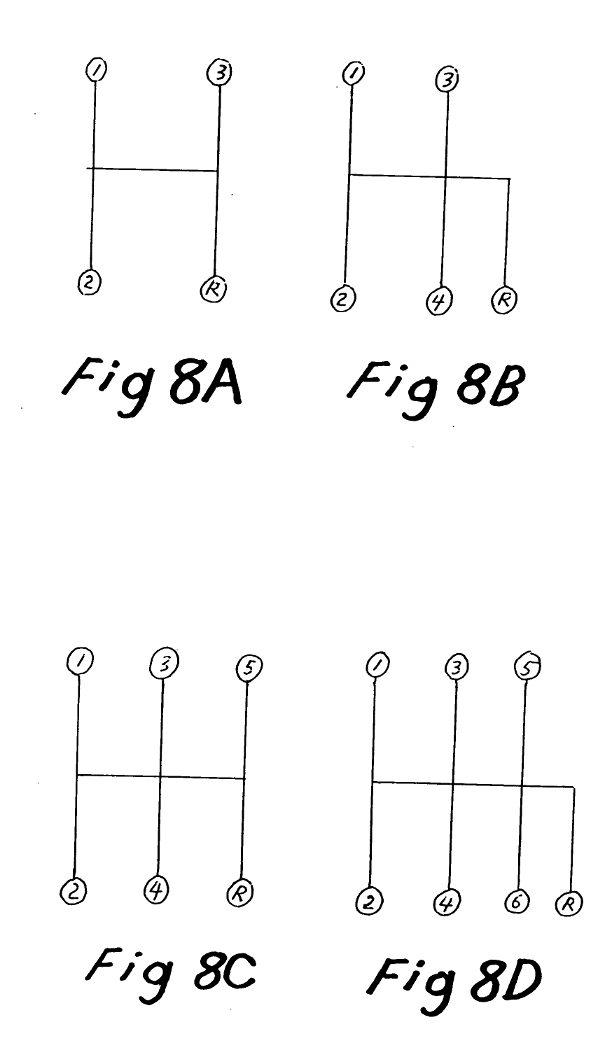

FIG. 7 shows an arrangement where Class 3 Lever 14 is oriented so its Fulcrum 18 is positioned near Shifter Frame 42, the same orientation as Shift Lever 22. This non-folded Class 3 Lever orientation of FIG. 7 (and FIG. 5), positions Transmission Linkage Rod 24 away from Shifter Frame 42, an option that works in some vehicles where there is sufficient configurable room in the shifter mechanism and associated housing.

FIGS. 8A thru 8D show typical ‘H’ patterns. The Numerals and Letter shown are typical shifter forward and reverse gear labels respectively. It is not the object of this invention to determine shifter patterns, but rather to accommodate existing shifter patterns. For example, vehicle transmissions typically employ two linkages; one linkage responds to fore/aft motion of the Shifter Handle, and the other linkage responds via existing articulation means, to the side motion of the Shifter Handle. Both linkage actuators push and pull their respective transmission linkage rods by virtually identical actions. It is therefore possible to provide separate short-throw ratios for both the fore/aft motion and the sideways motion of the Shifter Handle by employing two of the present inventions in the vehicle.

Manufacturers currently mount shifter mechanisms in a variety of different locations in their vehicles. The term “Four on the Floor” refers to shifters mounted directly on the floor of the vehicle. Column mounting is another shifter location option employed by vehicle manufacturers. Console mounting, and dashboard mounting, are other popular shifter locations currently in use. It is not the intent here to dictate any specific shifter mounting method, but to show how each of these, and other shifter mounting options can benefit from the present invention, particularly when space constraints restrict shift-throw mechanism room.

Therefore, this invention teaches means to achieve the desired result of aftermarket shortening of vehicle shifter throws within the confined space existing in many vehicle shifter mounting configurations. Paramount among these instant means are (i) the use of Class 3 Leverage action, thereby easily achieving from 10% to 90% or greater shifter throw shortening, (ii) folding the Class 3 Leverage action, which co-acts with an optional non-straight Fulcrum means to create clearance for operating the modified transmission linkage in an efficient manner, and (iii) offsetting the Class 3 Leverage means, and the Transmission Linkage, a distance determined by the length of an Effort Arm.

The Class 3 Lever's Fulcrum, Effort, and Load force points, need not all be in a straight line. The Class 3 Lever can be doglegged in shape for at least two reasons, (i) to connect tangentially with the Load and Fulcrum forces if they are not parallel with each other. Or, (ii) space limitations prevent the Fulcrum Point of the Class 3 Lever from locating to correctly adjust the Shifter Handle neutral position.

The present invention is directed primarily to fitting the shifter throw reduction means within the shifter console housing and boot, because that is usually the most convenient to install. However, it is within the scope of this teaching to position the Class 3 leverage means anywhere within the vehicle shifting linkage intermediate between the shifter handle and the transmission. The present invention has particular utility with newer cable shifted vehicles whose transmission shift cables extend directly into the transmission case limiting shifter retrofitting options.

With this in mind, extensions and modifications made to this invention remain within its scope and intent. For example, this invention is directed primarily to aftermarket vehicle modifications, however the means taught herein are also applicable to original vehicle manufacturing, although it is recognized that the luxury of designing a vehicle provides many options not available when aftermarket retrofitting.

The invention consists in the novel, articles, parts, constructions, arrangements, combinations, compositions, steps and improvements shown and described. Variations can be made from the instant description without departing from its teaching.

1. A vehicle shifter Transmission Linkage, including a Shifter Handle, comprising:
a motion multiplying Class 3 Lever positioned to operate intermediate between the Shifter Handle and the Transmission Linkage.

2. The linkage means of claim 1, where, the Class 3 Lever action is folded in articulation.

3. The linkage means of claim 2, where a non-straight Fulcrum means is attached to the Class 3 Lever.

4. The linkage means of claim 3, where the Fulcrum means is substantially a rod.

5. The linkage means of claim 3, where the Fulcrum means is substantially a cable.

6. The linkage means of claim 1, where an Effort Arm is connected intermediate between the Shifter Handle, and the Class 3 Lever.

7. The linkage means of claim 6, where a Linkage Entrance Bracket repositions the existing Transmission linkage by a distance that is substantially the cosine of the length of the Effort Arm, with respect to the included angle between the Effort Arm and the existing Transmission linkage, measured on the plane of articulation of the Class 3 Lever.

8. A cable shifted vehicle Transmission Linkage, comprising:
a motion multiplying Class 3 Lever positioned to operate intermediate between the Shifter Handle and the Transmission Linkage.

9. The linkage means of claim 8, where, the Class 3 Lever action is folded in articulation.

10. The linkage means of claim 9, where a non-straight Fulcrum means is attached to pivot on the Class 3 Lever's Fulcrum point.

11. The linkage means of claim 10, where the Fulcrum means withstands compression, such as a rod.

12. The linkage means of claim 10, where a Fulcrum means is a flexible tensioned member, such as a cable.

13. The linkage means of claim 8, where an Effort Arm is intermediate between, and directly connected to pivot on, the Shifter Handle Lever's load point at one end, and the Class 3 Lever's effort point at the other.

14. The linkage means of claim 13, where
a Linkage Entrance Bracket repositions the existing Transmission linkage by a distance that is substantially the cosine of the length of the Effort Arm, with respect to the included angle between the Effort Arm and said Transmission linkage, to the extent they are not parallel, when the Shifter Handle is in its neutral position.
